(19) United States
(12) Patent Application Publication
(10) Pub. No.: US 2007/0110129 A1
(43) Pub. Date: May 17, 2007

(54) Method for measuring frequency characteristic and rising edge of impulse response, and sound field correcting apparatus

(75) Inventor: Kohei Asada, Kanagawa (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/586,375

(22) Filed: Oct. 25, 2006

(30) Foreign Application Priority Data
Oct. 31, 2005 (JP) JP 2005-315738

(51) Int. Cl. H04B 1/00

(52) U.S. Cl. 375/142

(57) ABSTRACT

A method for measuring a frequency characteristic of a system for measurement, in which the length of an impulse response of the system is greater than the length N of a TSP (time stretched pulse) signal, is provided. The method includes the steps of supplying the TSP signal to the system continuously for a predetermined number of times, adding and averaging output signals each having the length N, and performing circular convolution on a value obtained by the adding and averaging so that the frequency characteristic of the system is obtained.

### CROSS REFERENCES TO RELATED APPLICATIONS

The present invention contains subject matter related to Japanese Patent Application JP 2005-315738 filed in the Japanese Patent Office on Oct. 31, 2005, the entire contents of which are incorporated herein by reference.

### BACKGROUND OF THE INVENTION

1. Field of the Invention

The present invention relates to a method for measuring a frequency characteristic and a rising edge of an impulse response, and a sound field correcting apparatus.

2. Description of the Related Art

With the growing popularity of DVDs (Digital Versatile Discs) and digital broadcasting, multi-channel audio systems have become increasingly widespread in general households. This has increased the need for listeners (users) to perform various setting and adjustment operations of audio channels by themselves.

However, setting and adjustment operations in multi-channel audio systems are complicated and are often very difficult for users who are not skilled in operation of this type of system. Thus, attempts have been made to enable devices in multi-channel audio systems such as AV amplifiers to perform correction processing in audio reproduction, so as to simplify or setting and adjustment to be performed by the users or omit the need for such setting and adjustment.

Such correction processing is referred to as, for example, “automatic sound field correction”, in which correction is performed on the basis of a result of measurement of an impulse response in a reproduction sound field. Specifically, the following processing procedure may be performed: (a) an impulse signal as shown in the left side of FIG. 14A is supplied to a speaker of a channel of interest so that impulse sound is emitted; (b) the impulse sound is picked up by a microphone installed at a listening position of a user, and a signal representing an impulse response of a reproduction sound field (impulse response signal) as show in the right side of the FIG. 14A is obtained; (c) the impulse response signal is analyzed so that parameters for sound field correction are obtained; (d) an audio signal of the channel of interest is corrected using the parameters for sound field correction.

However, the use of an impulse can degrade the S/N ratio of an output signal of a microphone. Thus, a technique has been developed in which an impulse is converted into pulse in which the energy of the impulse is dispersed in the time domain, and the converted pulse is used for sound field correction.

The pulse obtained through the conversion above is referred to as a “TSP (Time Stretched Pulse)”. An example of a waveform of a TSP signal is shown in the left side of FIG. 14B, in which N represents the length of a TSP, indicating the total number of samples in one TSP signal (N=4096, for example) and TN represents a period of N samples (unit period).

In this case, in order to convert an impulse into a TSP, the phase of pulse contained in the impulse is advanced in proportion to the square of the frequency. In order to convert the TSP back to the impulse, the phase of pulse contained in the TSP is retarded in proportion to the square of the frequency.

Specifically, the impulse is transformed using equations (1) and (2) shown in FIG. 15, so that the TSP in which the energy of the impulse is dispersed in the time domain can be obtained. The TSP is inversely transformed using equations (3) and (4) shown in FIG. 15, so that the dispersed energy is compressed and the impulse can be obtained again, as shown in the left side of FIG. 14A and the left side of FIG. 14B.

Thus, when a TSP is employed, the following processing procedure can be performed: (e) the above processing of (a) and (b) is performed using a TSP signal instead of an impulse signal, so that a signal representing a TSP response in a reproduction sound field can be obtained as shown in the right side of FIG. 14B; (f) the dispersed energy in the TSP response signal is compressed again so that the TSP is inversely transformed to obtain an impulse response signal as shown in the right side of FIG. 14A; (g) the processing of (c) and (d) is performed using the impulse response signal.

With this TSP method, since the impulse energy is dispersed in the time domain, the S/N ratio of an output signal of a microphone is improved, and thus the accuracy of sound field correction is increased.

FIGS. 16A and 16B are diagrams illustrating a timing in measurement of an impulse response using a TSP. As shown in the figures, a TSP signal comprises 4090 samples (N=4096) and is supplied to a speaker during each of periods T1, T2, . . . , and Tk. This indicates that a TSP response signal is output from a microphone with a delay of a period Td for each of the periods T1, T2, . . . , and Tk.

In this example, the length of each of the periods T1 to Tk is same as that of a period TN. In the delay time Td, a leading period Ta corresponds to a distance between the speaker and the microphone, and a trailing period Ts corresponds to a system delay. Thus, the period Ta depends on the distance between the speaker and the microphone, and the period Ts has a predetermined value. The TSP response signals corresponding to the TSP signals are obtained k times. At this time, these TSP response signals are the same as each other.

Accordingly, when the TSP response signals are examined for each of the periods T1, T2, T3, . . . , and Tk, the TSP response signal obtained during the period T2 can be considered as corresponding to the TSP supplied during the period T2. During this period T2, the first measurement of TSP response can be performed.

In addition, the TSP response signal obtained during the period T3 is considered as corresponding to the TSP supplied during the period T3. Thus, the second measurement of TSP response can be performed during the period T3. Likewise, the TSP response signal obtained during the period Tk can be considered as corresponding to the TSP supplied during the period Tk. Thus, the (k−1)th measurement of TSP response can be performed during the period Tk.

However, it is not possible to consider that the TSP response signal obtained during the period T1 is the TSP supplied during the period T1, since the TSP signal contains a noise signal representing the background noise. Thus, TSP response may not be measured during the period T1.

As can be seen from the foregoing, when TSP sound is continuously output k times, (k−1) TSP response signals can be obtained. These (k−1) TSP response signals are basically the same as each other and thus can be synchronously added together. At this time, the TSP response signals are averaged, and as a result influence of signal variance and noise is reduced to a negligible level.

Techniques related to the above technique are described in the following documents:

Nobuharu Aoshima, “Computer-generated pulse signal applied for sound measurement”, J. Acoust. Soc. Am., No. 69(5), May 1981;

Yoiti Suzuki, et al., “An optimum computer-generated pulse signal suitable for the measurement of very longimpulse responses”, J. Acoust. Soc. Am., No. 97(2), February 1995;

Yoiti Suzuki, et al., “Considerations on the design of time-stretched pulses”, Technical Report of IEICE, EA92-86(1992-12);

Hutoshi Asano “Measuring impulse response using TSP”, RWCP Sound Scene Database in Real Acoustical Environments, 5 Feb. 2001, available from http://tosa.mri.co.jp/sounddb/tsp/tsp_circular.htm.

According to the above documents or other documents, in measuring an impulse response using a TSP, the length N (the number of samples) of the TSP needs to be greater than that (the number of samples) of the corresponding impulse response (i.e., a period lasting until the effective amplitude become sufficiently small), as shown in FIGS. 14A and 14B. Thus, the following equation has to be satisfied.
N>ν (5)

This can also be understood from FIG. 16. As illustrated in the figure, when the effective period of the TSP response signal increases, an effective portion or “tail” of a TSP response signal is superimposed around the leading part of the subsequent TSP response signal.

Thus, for example, when the sampling frequency of the TSP is 48 kHz and the reverberation time is 0.5 seconds, the length N of the TSP will be greater than 24000 samples (=0.5 seconds). When a FFT (fast Fourier transform) technique is used for inversely transforming a TSP, the length N is equal to a power of two and thus the length N is 32768 in this example.

If a sound field has a longer reverberation time which is based on the size of a room and reflecting objects, the length of an impulse, a longer impulse response (ν) is obtained and thus a longer TSP, which is corresponding to the impulse response, will be obtained. This disadvantageously causes an increase in measuring time and in resources necessary in the measurement such as a CPU, a DSP, and memory.

### SUMMARY OF THE INVENTION

The present invention has been made in view of the above circumstances.

Accordingly, in a method for measuring a frequency characteristic of a sound field between a sound source and a receiver, N denotes the length of a TSP signal, ν denotes the length of an impulse response between the sound source and the receiver, TN denotes a duration period of the TSP signal, and T1 to T(k+L) denote periods each composed of the period TN as a unit period (k≧1, L≧0). This method includes the steps of setting N so as to satisfy N≦ν, supplying the TSP signal to the sound source continuously for each unit period TN over the periods T1 to Tk, adding and averaging signals output from the receiver during the individual periods T1 to T(k+L), and performing circular convolution on a value obtained by the adding and averaging so that the frequency characteristic of the sound field between the sound source and the receiver is obtained.

According to an embodiment of the present invention, TSP sound is continuously output to a reproduction sound field, and addition/averaging and circular calculation is performed on corresponding TSP response signals. This permits a decrease in the time necessary for measurement of impulse response and a reduction in resources necessary for the measurement such as a CPU, a DSP, and a memory.

### BRIEF DESCRIPTION OF THE DRAWINGS

FIGS. 1A to 1D illustrate a timing diagram illustrating an embodiment of the present invention;

FIG. 2 illustrates an embodiment of the present invention;

FIGS. 3A and 3B are waveform diagrams illustrating an embodiment of the present invention;

FIGS. 4A and 4B are waveform diagrams illustrating an embodiment of the present invention;

FIGS. 5A and 5B are waveform diagrams illustrating an embodiment of the present invention;

FIG. 6 illustrates an embodiment of the present invention;

FIG. 7 illustrates an embodiment of the present invention;

FIG. 8 is a flowchart illustrating signal processing according to an embodiment of the present invention;

FIG. 9 is a flowchart illustrating signal processing according to an embodiment of the present invention;

FIGS. 10A to 10C are waveform diagrams illustrating an embodiment of the present invention;

FIG. 11 is a waveform diagram illustrating an embodiment of the present invention;

FIG. 12 is a characteristic diagram illustrating an embodiment of the present invention;

FIG. 13 is a block diagram illustrating a system according to an embodiment of the present invention;

FIGS. 14A and 14B are waveform diagrams illustrating a TSP signal;

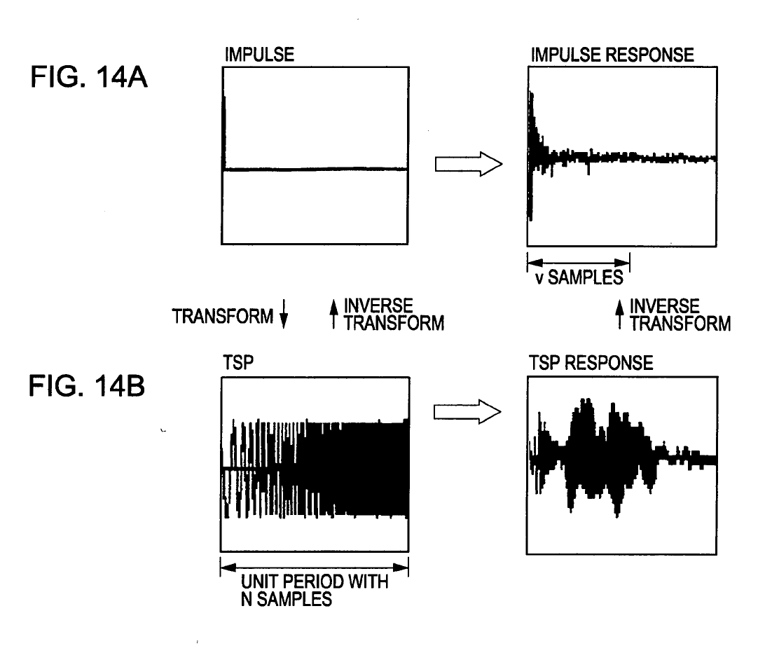

FIG. 15 illustrates a TSP signal; and

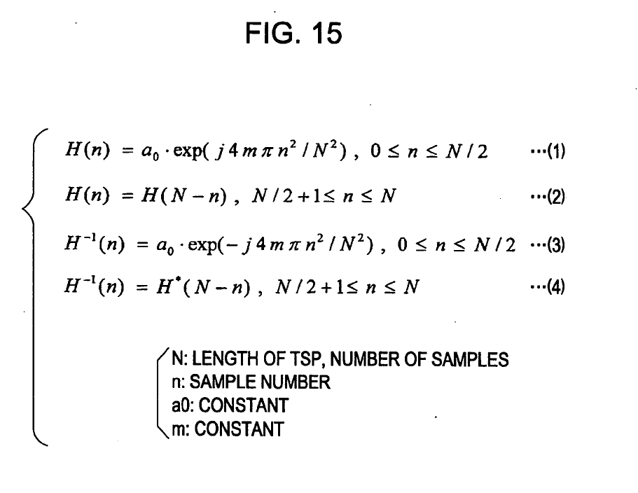

FIGS. 16A and 16B are waveform diagrams illustrating a TSP signal.

### DESCRIPTION OF THE PREFERRED EMBODIMENTS

[1] Concept of the Present Invention

In known measurement techniques, as described in the above documents or other documents, a TSP used for impulse response measurement is prepared after it has been verified that the length N of the TSP as an output and the length ν of an impulse response in a reproduction sound field can satisfy the above equation (5).

However, for a normal sound field, it is sufficient to correct the frequency response characteristics and time alignment (time delay correction), and thus only acquisition of parameters for the correction is necessary.

Accordingly, the present embodiment is intended not for “accurate calculation of an impulse response” but for “accurate derivation of parameters for correction of a sound field”. Thus, a TSP which is shorter than a reverberation time as expressed by the following equation is used.
N≦ν (6)
Specifically, TSP sound corresponding to such a TSP is continuously output to a reproduction sound field so that parameters used for sound field correction can be obtained through addition/averaging and circular calculation. This allows reduction of a measuring time as well as resources used in the measurement such as a CPU, a DSP, and a memory.
[2] Frequency Characteristic (Frequency Amplitude Characteristic)

A frequency characteristic can be obtained by performing adequate synchronous addition, even when the values of N and ν have a relationship expressed by the equation (6). This will be described in more detail below.

[2-1] TSP Response Signal

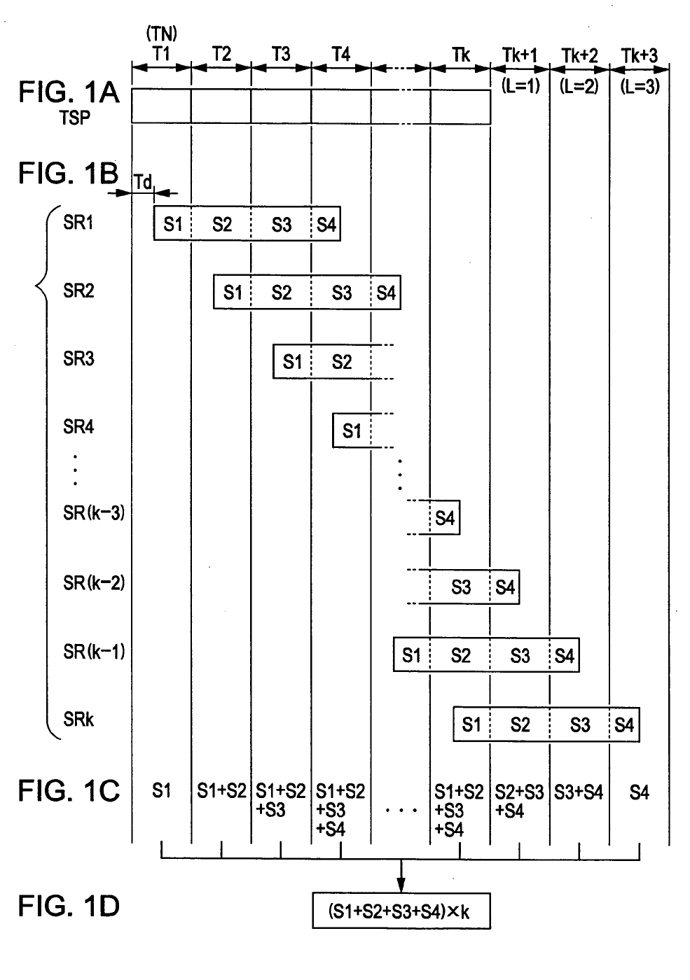

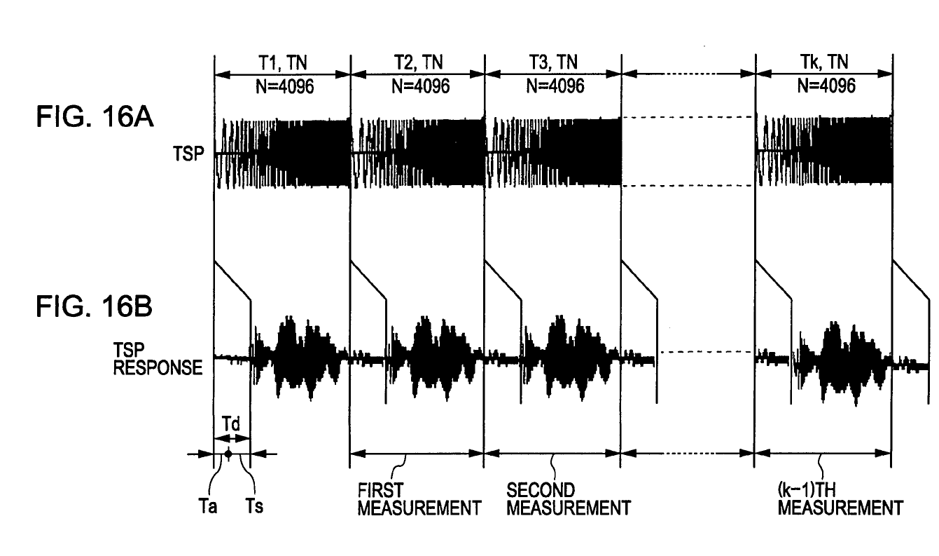

FIGS. 1A to 1D shows a timing diagram illustrating measurement of a TSP response using a TSP. As show in FIG. 1A, a TSP signal is composed of 4096 samples (N=4096). This TSP signal is continuously supplied to a speaker during each of periods T1, T2, . . . , and Tk. In this embodiment, the value of k is assumed to be ten, similarly to the case described using FIG. 16.

Thus, as shown in FIG. 16B, a TSP response signal SR1 is obtained from TSP sound emitted in the period T1. FIG. 1 illustrates a case where one TSP response signal is obtained over a four-unit period TN. Thus, the TSP response signal SR1 is obtained over the periods T1 through T4 with a delay of a period Td from the start point of the period T1.

When a sampling frequency of the TSP signal output as TSP sound is 48 kHz, the unit period TN is 4096/48000≈85.3 [ms]. When the velocity of sound in air is 340 m/s, the propagation distance of an acoustic wave is 340 [m/s]×85.3 [ms]≈29 [m]. Thus, in an ordinary room in which AV (Audio/Visual) reproduction is performed, Td<TN is satisfied, and the head of the TSP response signal SR1 is within the period T1 (i.e., the TSP response signal SR1 is output during the period T1).

A TSP response signal SR2 is obtained from TSP sound emitted over the periods T2 to T5. Likewise, from TSP sound emitted in a period T1 (i=1 to k), a TSP response signal Sri is obtained over periods T1 to T (i+3).

Then, as shown in FIG. 1, in TSP response signal SR1, a signal component corresponding to the period T1 is assumed to be a signal S1, and likewise, a signal component corresponding to the period T2 to be S2, a signal component corresponding to the period T3 to be S3, a signal component corresponding to the period T3 to be T4.

The subsequent TSP response signal SR2 is basically the same as the signal SR1 except that the signal SR2 is shifted by the unit period TN from the signal SR1. Thus, in the TSP response signal SR2, a signal component corresponding to the period T2 can be regarded as the signal S1, a signal component corresponding to the period T3 as the signal S2, a signal component corresponding to the period T4 as the signal S3, and a signal component corresponding to the period T5 as the signal S4.

Likewise, since the TSP response signals SR1 to SRk are the same as each other except that the start point of each of these signals are shifted by TN, for any TSP response signal SR1, a signal component corresponding to a period Ti can be regarded as the signal S1, and a signal component corresponding to a period T (i+3) can be regarded as the signal S4.

In the actual situation, an output signal from a microphone is a signal composed of the signals SR1 to SRk added together. Thus, as shown in FIG. 1C, the signal S1 is obtained in the period T1, a signal (S1+S2) is obtained in the period T2, a signal (S1+S2+S3) is obtained in the period T3, and a signal (S1+S2+S3+S4) is obtained in the period T4. Similarly, in each of the periods T5 to Tk, the signal (Si+S2+S3+S4) is obtained.

Since no TSP sound is emitted during periods T(k+1) to T (k+3), a signal (S2+S3+S4) is obtained in the period T(k+1), a signal (S3+S4) is obtained in the period T (k+2), and the signal S4 is obtained in the period T (k+3).

Then, as shown in the bottom of FIG. 1D, the individual signals obtained during the periods T1 to T (k+3) are added together as follows:

$$S 1 + ( S 1 + S 2 ) + ( S 1 + S 2 + S 3 ) + ( S 1 + S 2 + S 3 + S 4 ) \times ( k - 3 ) + ( S 2 + S 3 + S 4 ) + ( S 3 + S 4 ) + S 4 = ( S 1 + S 2 + S 3 + S 4 ) \times k ≡ k \cdot SW \qquad ( 7 )$$

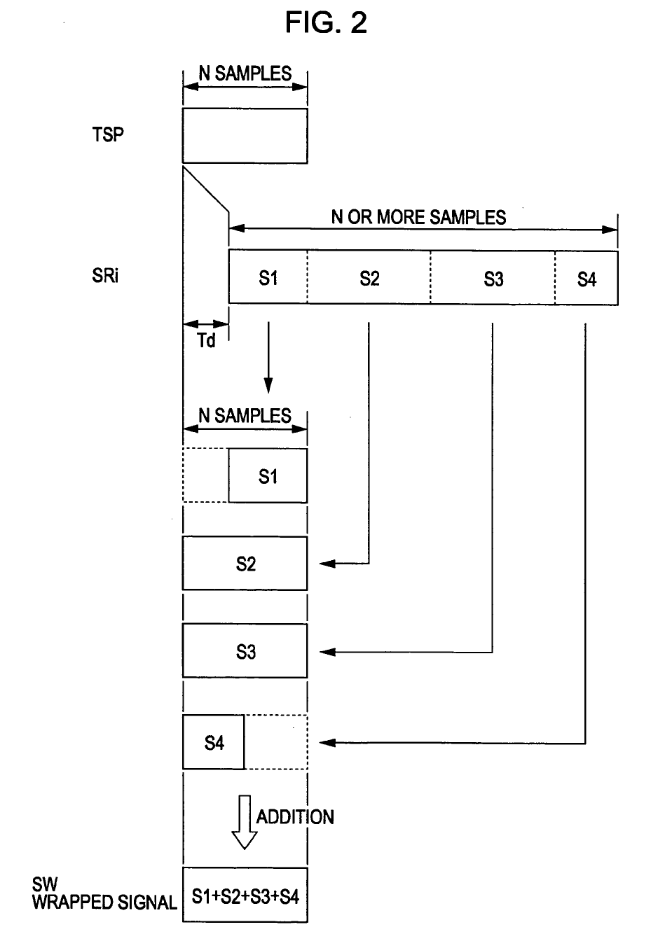

Specifically, the TSP response signals SR1 to SRk obtained during the periods T1 to T (k+3) are divided with respect to each unit period TN, and the signals obtained in the individual periods T1 to T (k+3) are added together. The result is divided by the number k of TSP sound emissions so as to be averaged. Consequently, as shown in FIG. 2, a signal Sw is obtained which is composed of the signals S1 to S4 of the TSP response signal SR1 for each N-sample period TN.

In a general way, when TSP sound is emitted k times during the periods T1 to Tk, response signals corresponding to the TSP sound are measured (k+L) times for each N-sample period TN during the period T1 to T (k+L). Then the response signals are added and averaged so that the signal Sw is obtained. The value L is the number of no-sound periods, subsequent to the period Tk, during which TSP response sound is picked up, which will be described in detail below.

If a sufficiently acceptable result of frequency analysis performed on the signal Sw can be obtained as the frequency characteristic, the signal Sw can be used for deriving a parameter for sound field correction. This is described below. The Sw signal, which has been obtained through addition and averaging of the TSP response signals SR1 to SRk for each unit period TN, is hereinafter referred to as a “wrapped signal”, and the addition/averaging processing for the wrapped signal is hereinafter referred to as “wrapping processing”.

[2-2] Comparison Between Characteristics of Impulse Response Signal and Wrapped Signal

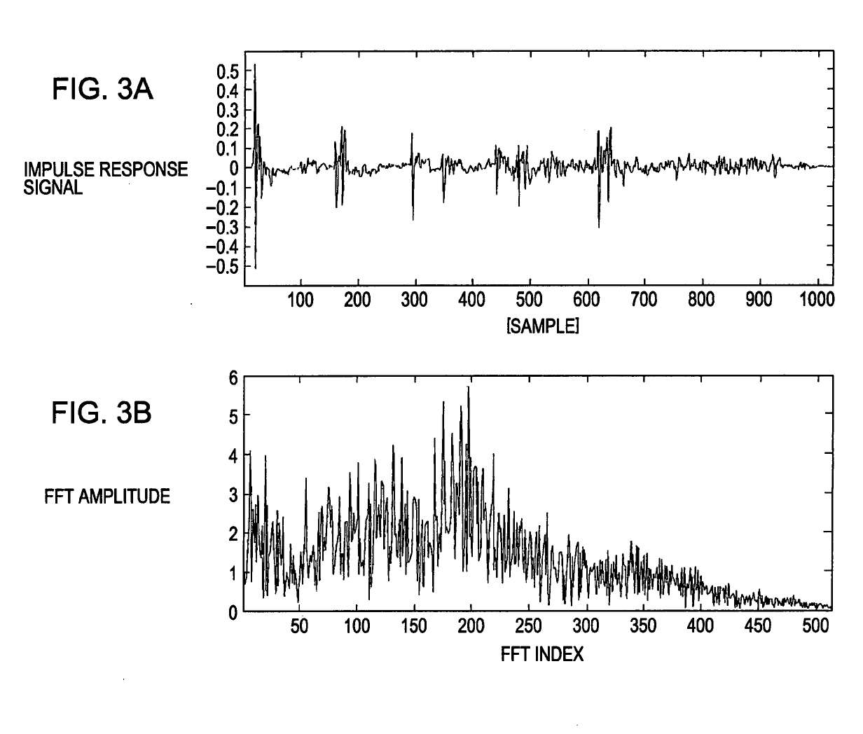

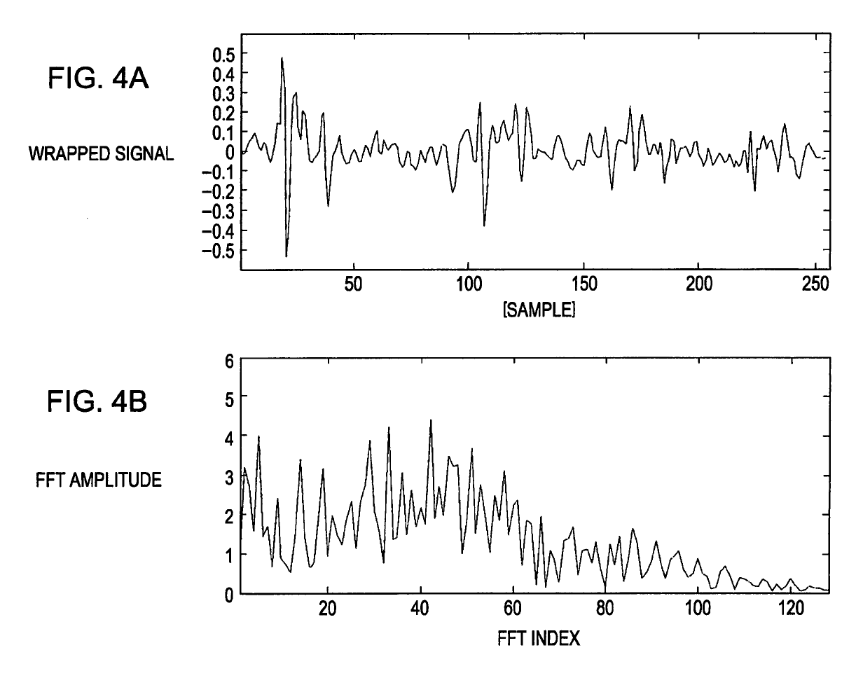

In the following, waveform characteristics of an impulse response signal and a generated wrapped signal will be described. FIG. 3A illustrates an example of a waveform of an impulse response signal with 1024 samples, and FIG. 3B illustrates a waveform showing amplitude values obtained by performing an FFT on the impulse response signal. FIG. 4A illustrates a waveform of a wrapped signal which has undergone wrapping processing for each N-sample period (N=256), as described using FIGS. 1 and 2. FIG. 4B illustrates a waveform showing amplitude values obtained by performing an FFT on the wrapped signal. Note that the X-axes of FIG. 3 and FIG. 4 have different pitches (scales).

It can be seen that the waveform showing the FFT amplitudes shown in FIG. 3B and the waveform showing the FFT amplitudes shown in FIG. 4B resemble each other in general shape.

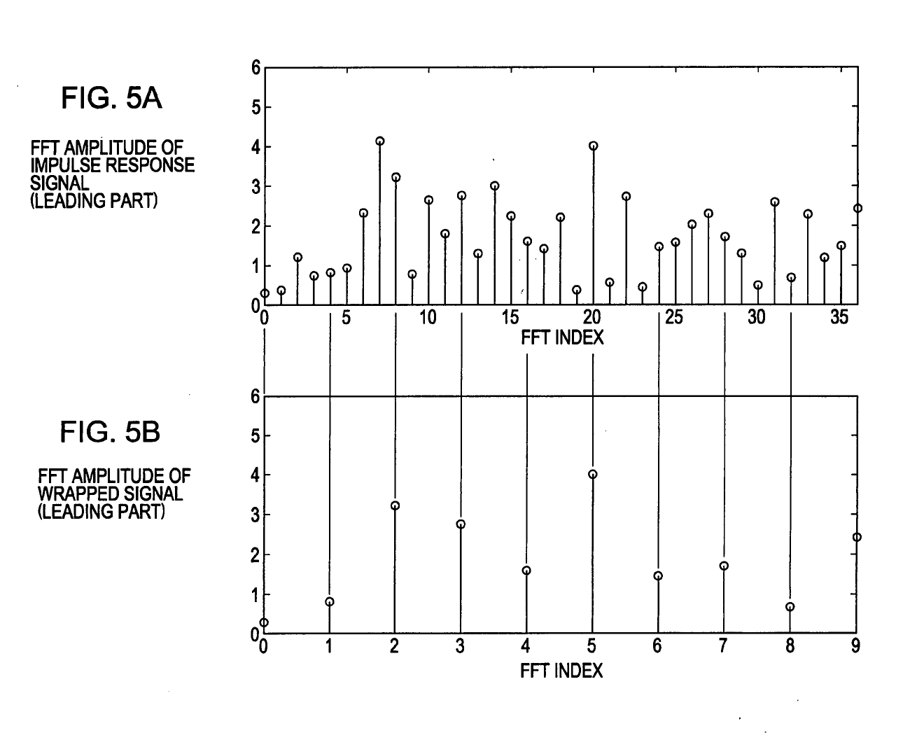

FIG. 5A illustrates a leading part of the FFTed impulse signal (i.e., a leading part of the waveform illustrating the FFT amplitudes shown in FIG. 3B). FIG. 5B illustrates a leading part of the FFTed impulse signal (i.e., a leading part of the FFTed wrapped signal shown in FIG. 4B). As can be seen from FIGS. 5A and 5B, the FFT amplitudes of the wrapped signal and the FFT amplitudes of the impulse response signal agree every four samples.

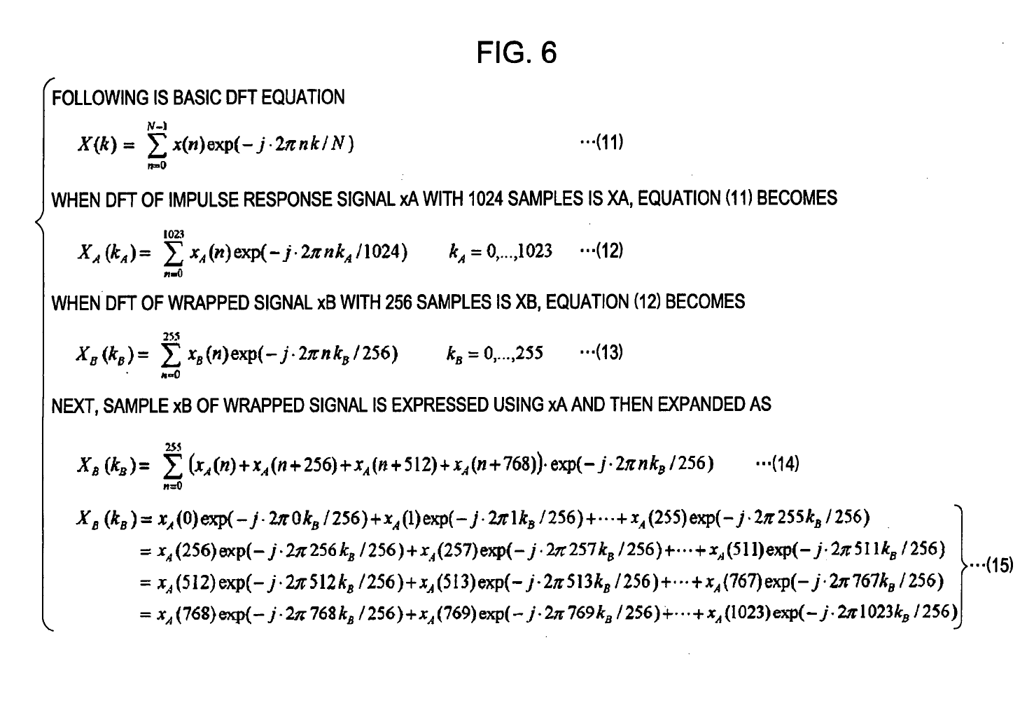

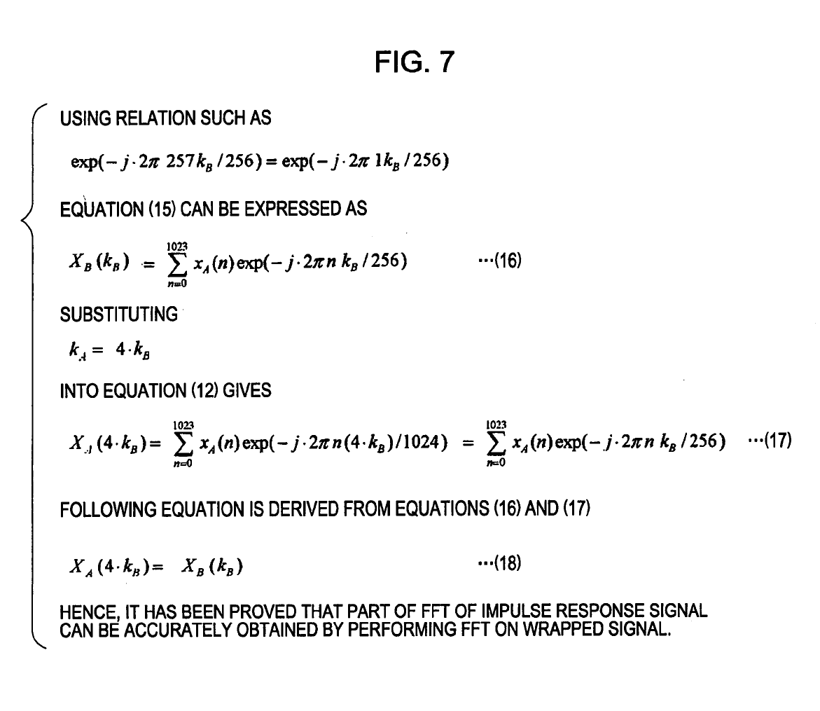

This agreement can be analyzed using formulas shown in FIGS. 6 and 7. As can be seen from the set of formulas, it is proved that a resultant FFT output of the wrapped signal is a part of a resultant FFT output of the impulse response signal.

Therefore, although a resolution obtained by analyzing the waveform of the wrapped signal by an FFT technique is lower than that obtained by analyzing the waveform of the impulse response signal by an FFT technique. However, in the frequency domain, the analysis of the waveform of the wrapped signal and the analyzing the waveform of the impulse response signal result in the same values. Accordingly, even in the case where the equation (6) is satisfied, i.e., where an impulse response signal in the actual sound field lasts for a period of 4096 or more samples, an accurate frequency characteristic can be measured using a wrapped signal, and thus an appropriate parameter for sound field correction can be obtained.

[2-3] Value L

When a frequency characteristic is measured using a TSP, as described above, the value L is set in accordance with the impulse response in a sound field of interest. This allows precise measurement of a frequency characteristic even in the case where the equation (6) is satisfied.

However, in order to set the value L to be associated with an impulse response, it is necessary to obtain the reverberation time of the sound field in advance. In this case, an increase in the value L means an increase in the sound pickup period T (k+1) or a later period (i.e., in a period during which no TSP sound is emitted). This indicates that noise signals representing the background noise are repeatedly added until the TSP response signal becomes sufficiently small. In addition, when the value L is set to be a fixed value, the pickup period may be unnecessarily long for a sound field with a short reverberation time, resulting in an increase in the measuring time.

Accordingly, in view of the S/N ratio and measuring time, it is desirable that L is decreased for a sound field with a short reverberation time and increased for a sound field with a long reverberation time.

The variable m of the equations (1) and (3) is a parameter associated with the length N of a TSP. However, the value m is not determined by the length ν of an impulse response. Thus, by setting the value m to be a value close to 2, a large phase rotation of a TSP signal can be obtained, resulting in a decrease in the amplitude of the TSP signal. Consequently, the gain of a measuring signal can be increased, which permits efficient measurement in terms of the S/N ratio.

[2-4] Example of Determination Scheme of Value L

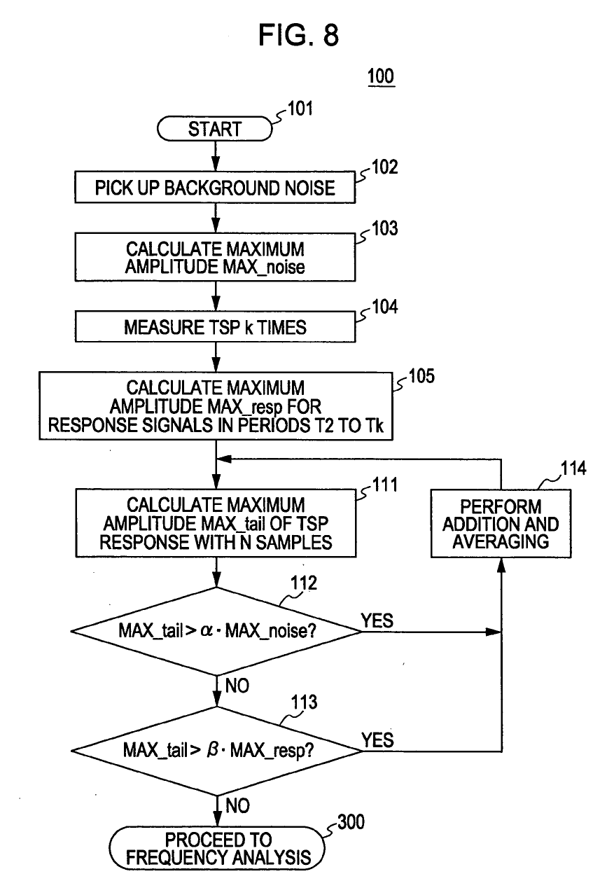

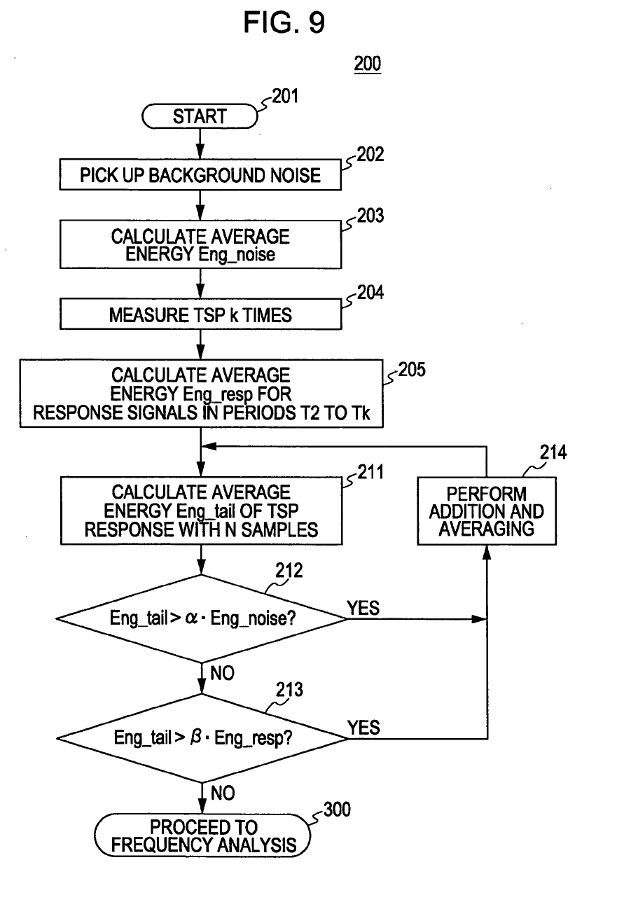

FIGS. 8 and 9 show examples of algorithms for determining the value L. In each of these algorithms, the following processing procedure is performed: A. The magnitude of the background noise is measured in a preliminary period; B. Processing for the periods T1 to Tk is performed; C. On the basis of the maximum value or the average value of the background noise as a reference value, the level of a picked-up response signal is checked in real time for each period TN after the period T (k+1) and thereafter; D. On the basis of the result of the check, whether the processing is continued or terminated is determined.

[2-4-1] When the Maximum Value is Used

The maximum value can be used in the algorithm shown in FIG. 8, in which the last period T (k+3) is determined on the basis of the maximum values of a background noise signal and a picked-up response signal. Specifically, in a routine 100 illustrated in the FIG. 8, processing is initiated at STEP 101 in response to an instruction of measurement of a frequency characteristic. At STEP 102, the background noise is picked up for a predetermined period TN×M (M is a natural number). At STEP 103, the maximum amplitude value MAX_noise of the picked-up signal is calculated.

At STEP 104, TSP sound is emitted during the periods T1 to Tk, as described using FIG. 1. At the same time, TSP responses corresponding to the TSP sound is picked up during the periods T2 to Tk, and the TSP response signals are added together for each unit period TN so that a wrapped signal Sw is generated for each of the periods T2 to Tk, as described with reference to FIG. 1. Then, at STEP 105, the maximum amplitude value MAX_resp of the wrapped signal Sw is calculated.

At STEP 111, as shown in FIG. 1, no TSP sound is output during the subsequent period T(k+1) (L=1). However, TSP response sound is picked up, and the maximum amplitude value MAX_tail of the picked-up TSP response signal (i.e., the maximum amplitude value in the period T (k+1)) is calculated. At STEP 112, the maximum amplitude value MAX_tail is compared with a value (α·MAX_noise) obtained by multiplying the maximum amplitude value MAX_noise of the background noise calculated in STEP 103 by a predetermined magnification factor α (α>1).

In the above comparison, if MAX_tail>(α·MAX_noise), indicating that TSP response has been obtained, the processing procedure proceeds to STEP 114. At STEP 114, the TSP response signal picked up in the period T(k+1) in STEP 111 is added to the wrapped signal Sw corresponding to the periods T2 to Tk and the resultant value is averaged. Then, the procedure returns to STEP 111. At this time, the wrapped signal Sw is formed by adding and averaging the TSP response signals corresponding to the periods T2 to T(k+1).

Thereafter, the processing of STEP 111 to STEP 114 are repeated for each of the periods T (k+2) and T (k+3). Consequently, the wrapped signal Sw is a signal formed by adding and averaging the TSP response signals corresponding to the periods T2 to T (k+3).

In the period T (k+4), no TSP response is output, and only the background noise is present. At this time, since MAX_tail≦(α·MAX_noise), the procedure proceeds to STEP 113. AT STEP 113, the maximum amplitude value MAX_tail calculated in STEP 111 is compared with a value (β·MAX_resp) obtained by multiplying the maximum amplitude value MAX_resp of the wrapped signal Sw calculated in STEP 105 by a predetermined magnification factor (0<β≦1).

In the above comparison, if MAX tail≦(β·MAX_resp), indicating that no TSP response has been obtained, the procedure proceeds to STEP 300. At this time, the wrapped signal Sw is formed by adding and averaging the TSP response signals corresponding to the periods T2 to T (k+3). Thus, frequency analysis or the like can be performed on the wrapped signal Sw so that a parameter used for sound field correction can be obtained.

On the other hand, if MAX_tail>(β·MAX_resp), indicating that the TSP response is still present, the procedure proceed to STEP 114 and then returns to STEP 111. Specifically, the termination of the TSP response signal is checked in both STEP 112 and STEP 113, and the TSP response signal is determined to have been terminated in both of STEP 112 and STEP 113, the wrapped signal Sw is analyzed and used for obtaining a parameter for sound field correction such as correction of the frequency characteristic.

Thus, according to the routine 100, a wrapped signal Sw corresponding to TSP response signals can be appropriately obtained. This allows generation of a parameter for correction of the frequency characteristic.

[2-4-2] When Average Value is Used

The average value can be used in the algorithm shown in FIG. 9, in which the last period T (k+3) is determined on the basis of the average energy values of a background noise signal and a picked-up response signal. This processing is realized by a routine 200 illustrated in FIG. 9. Processing procedure in this routine 200 is similar to that in the routine 100, the description of thereof is omitted. The reference numerals assigned to each processing of the routing 200 are different from those assigned to the corresponding processing of the routine 100. In addition, in the routine 200, “Eng_noise” denotes the average energy of the TSP response signal, “Eng_resp” denotes the average energy of the wrapped signal Sw, and “Eng_tail” denotes the average energy of the TSP response signal for each period TN of the period T (k+1) and later periods.

Also in this routine 200, a wrapped signal Sw can be appropriately obtained, and thus a adequate parameter for correction of the frequency characteristic can be generated.

[2-4-3] Supplementary Explanation

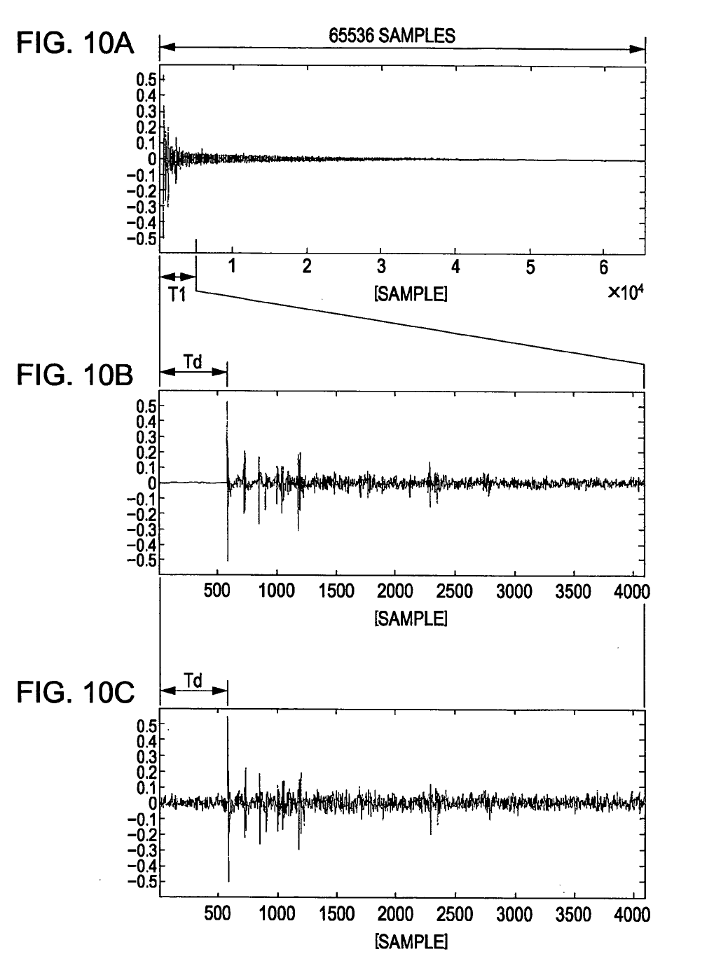

FIG. 10A illustrates an example of measurement in which an impulse response is measured over a 65536-sample period. As can be seen from the figure, the energy of the impulse response is concentrated in the initial 4096-sample period T1 (=TN) when emitted within an expected range, and energy in the subsequent periods is significantly decreased.

Basically a TSP can be considered as being composed of an impulse train in different time instances. Therefore, the energy of the leading pulse contained in the TSP is concentrated in the initial period T1 in a corresponding TSP response signal. Likewise, the energy of the trailing pulse contained in the TSP is concentrated in the subsequent 4096-sample period T2 in the TSP response signal. In addition, as shown in the FIG. 1, k TSP response signals SR1 to SRk are added and averaged so that the wrapped signal Sw is generated.

Thus, as the value k increases, influence of the value L on the wrapped signal Sw decreases. Even when the value L is a fixed value, error in the wrapped signal Sw can be reduced. For example, if the value of k is 32, the appropriate wrapped signal Sw can be obtained even where L=0. In this case, the processing described above in which the level of the TSP response signal is checked using the maximum value or average value of the background noise is not necessary, and thus the entire processing procedure can be simplified.

[3] Time Alignment

In the following, a measuring method intended for time alignment when the values N and ν has the relationship expressed by the equation (6) will be described.

[3-1] Rising Edge of Impulse Response

In time alignment, a parameter necessary for sound field correction is a distance between a sound source such as a speaker and a receiver such as a microphone. The distance corresponds to the time Ta (i.e., a time period obtained by subtracting the system delay time Ts from the delay time Td), as described using FIG. 16. Therefore, an impulse response signal is acquired from the wrapped signal Sw, and a rising edge of the impulse response signal can be analyzed.

As described in the foregoing, an impulse response is acquired through inverse TSP processing as expressed be the equations (3) and (4) in circular convolution using DFT or FFT which is performed on a TSP response signal (shown in FIG. 1) obtained through continuous emission of TSP sound. However, the signal obtained through this technique is not an impulse response in a precise sense, but an impulse response which has undergone wrapping processing.

This may bring about a problem described below. As described above, FIG. 10A illustrate an example of measurement of an impulse response waveform. FIG. 10B shows an enlarged representation of the initial 4096-sample period T1 in the time domain. FIG. 10C illustrates a waveform of an impulse response obtained by performing inverse TSP filtering on a wrapped signal Sw. This wrapped signal Sw is generated under the same condition as that under which the impulse response waveform is obtained, by performing addition and averaging of TSP response signals for each 4096-sample period. This inverse TSP-filtered waveform is also shown in FIG. 10C as an enlarged representation of the initial 4096-sample period T1 in the time domain.

In each of FIGS. 10B and 10C, a large amplitude change observed in the vicinity of 600 samples represents the initial rise caused by an impulse or TSP, and a period between the head of the waveform and the initial rise corresponds to the delay period Td. In the case of FIG. 10B (actual impulse response signal), only a noise component representing the background noise is present during the period Td between the head of the waveform and the initial rise. Therefore, the signal level is sufficiently small, allowing an initial rise point (rising edge) to be distinguished.

Thus, in this case, the rising edge can be detected by setting a threshold level V_{TH}, by multiplying the maximum amplitude value of the impulse response signal by a predetermined ratio “a” (for example, “a”=20%). Then, a time point at which the impulse response signal exceeds the threshold level V_{TH} can be considered as the rising edge of the impulse response.

On the other hand, in the case of the FIG. 10C (impulse response signal obtained by inversely TSP-transforming the wrapped signal Sw (inverse-TSP impulse response signal)), signal components corresponding to the period T2 and later periods are added to the signal component corresponding to the initial period T1 for each sample period TN (N=4096). Thus, in the period Td, the signal components of the TSP response signal corresponding to the period T2 and later periods are present. As a result, the signal component of the inverse-TSP impulse response signal in the period Td has a certain amplitude, which reduces the distinguishability of the rising edge of the impulse response as compared with the impulse response signal of FIG. 1OB.

In setting of the threshold level V_{TH}, if a large ratio “a” to be multiplied with the maximum amplitude value is set, a high threshold level V_{TH} is obtained. This decreases precision in time for detecting the rising edge of a waveform. On the other hand, however, a small ratio “a” results in a low threshold level V_{TH}, which increases possibility of error in the detection of the rising edge. Specifically, amplitude fluctuation which occurs prior to the actual rise of the impulse response may be misrecognized as representing the rise of the impulse response.

Therefore, in the case of the inverse-TSP impulse response signal, it is not possible to set the threshold level V_{HT} by multiplying the maximum amplitude value of the impulse response signal by a predetermined ratio.

Accordingly, in this embodiment, the property described below is utilized so that the threshold level V_{TH} can be dynamically set.

[3-2] Measuring Method of Rising Edge of Impulse Response

As described above, the inverse-TSP impulse response signal does not represent an actual impulse response in a precise sense. In the following, a property of the reverberation characteristic of a typical impulse response in the time domain is employed: (A) in a waveform of a typical impulse response signal, energy of a reverberation component is smaller than that of a rising edge component and an initial reflected sound component subsequent to the edge component. Thus, a waveform of an inversely TSP-transformed impulse response signal is not significantly different in general shape from the waveform of a typical impulse response signal. This can be seen from the waveforms illustrated in FIGS. 10B and 10C, and the rising edge can be detected from the waveforms; (B) In an inverse-TSP impulse response signal, it is highly likely that a signal component in the period Td, which lasts from the head of the waveform to the rising edge, is a noise component representing the background noise or a reverberation component produced by wrapping processing. Thus, it is necessary to prepare an arrangement so that the amplitude in the period Td is not detected; (C) In general, the amplitude and energy of the reverberation component shows a generally simple decrease over time. For example, the amplitude of the impulse response waveform illustrated in FIG. 10A decreases along the time axis.

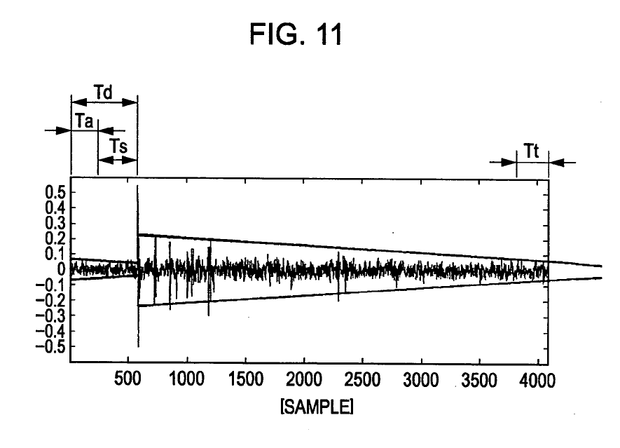

In addition, as can be seen from a waveform illustrated in FIG. 11 (same as the waveform in FIG. 10C), also in the inverse-TSP impulse response signal, the amplitude of a signal component corresponding to a period subsequent to the period Td (i.e., a period corresponding to the maximum amplitude and later periods) decreases over time. Since TSPs and TSP response signals (SR1 to SRk) are repeated for every unit period TN, it is possible to consider that the signal component corresponding to the periods Td follows the trailing end of the waveform in FIG. 11. Therefore, the amplitude in the period Td can also be considered as decreasing over time.

By utilizing the above-described properties of reverberation characteristic ((A)to (C)), the threshold level V_{TH} for detecting a rising edge of an impulse response can be determined in accordance with an algorithm described below.

Specifically, since the signal component in the period Td can be considered as subsequent to the trailing end of the waveform in FIG. 11, the period Td and a predetermined period Tt in the trailing part of the waveform are set as a detection period Tx for detecting the level of the background noise. The period Tt serves to provide a sufficient detection period in a case where the delay period Td is short.

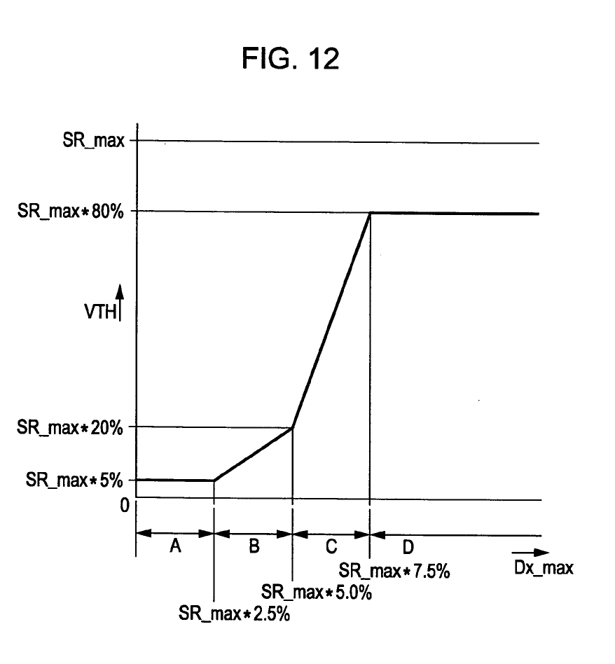

Referring to FIG. 12, an example of a characteristic diagram for determining the threshold level V_{TH} is shown. The abscissa represents the maximum amplitude value Dx_max of an inverse-TSP impulse response signal in the detection period Tx, and the ordinate represents the threshold level V_{TH}. A maximum value SR_max in the ordinate represents the maximum amplitude of the impulse response signal which corresponds to the rising edge.

In this characteristic diagram, the following conditions are satisfied:

(D) in section A (Dx_max≦SR_max·2.5%),

V_{TH}=SR_max·5%

(E) in section B (SR_max·2.5%<Dx_max≦SR_max·5%),

SR_max·5%<V_{TH}≦SR_max·20%

(F) in section C (SR_max·5%<Dx_max≦SR_max·7.5%),

SR_max·20%<V_{TH}≦SR_max·80%

(G) in section D (SR_max·7.5%<Dx_max)

V_{TH}=SR_max·80%.

In the section A in the abscissa, the threshold level V_{TH} is set by a fixed ratio (=5%) and is not associated with the maximum amplitude value Dx_max. Such a fixed ratio is used since noise is potentially present in a reproduction sound field, and the noise level of the sound field can be assumed to not exceed a predetermined level from a statistical point of view. In the section D, the threshold level V_{TH} is set to be 80% which is close to the maximum value. Two-phase gradients corresponding to sections B and C serve for transitioning between the section A and the section D.

As described above, the threshold level V_{TH} is dynamically changed in accordance with the noise level in the detection period Tx. This reduces possibility that an amplitude change which occurs prior to the actual rise time of an impulse response is misrecognized as corresponding to the rising edge of the impulse response.

[4] System Configuration

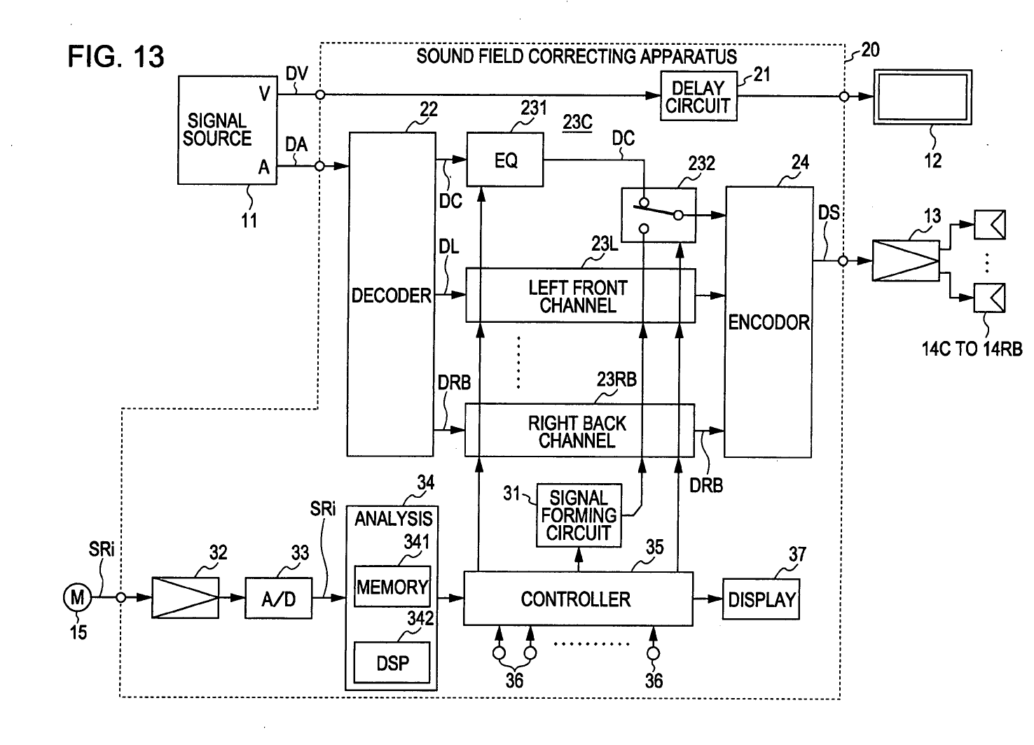

FIG. 13 illustrates a sound field correcting apparatus to which an embodiment of the present invention is applied. This sound field correcting apparatus is implemented as an adapter type for a known multi-channel AV (Audio/Visual) reproducing apparatus.

[4-1] AV Reproducing Apparatus

In FIG. 13, the AV reproducing apparatus includes a signal source 11 for generating an AV signal, a display 12, a digital amplifier 13, and speakers 14C to 14 RB. The signal source 11 may be a DVD player, a tuner for satellite broadcasting, or the like. The signal source 11 has a DVI (Digital Visual Interface) output, and a video signal DV is output as a digital signal. At the same time, digital audio signals for seven channels are encoded into a serial signal DA for output.

The display 12 has a DVI input. Thus, normally, the digital video signal DV output from the sound source 11 can be directly input to the display 12. The digital amplifier 13 includes a multi-channel decoder and is configured as a so-called class D amplifier. Specifically, it is normally possible to input the digital audio signal DA output from the sound source 11 to the digital amplifier 13. In addition, the digital amplifier 13 separates (decodes) the signal DA into signals for the individual channels and performs class D power amplification on the channel signals so as to output analog audio signals for the individual channels.

The audio signals output from the amplifier 13 are supplied to individual speakers 14C to 14RB corresponding to the channels. The speakers 14C to 14RB are installed positions in the center front, left front, right front, left side, right side, left back, and right back, respectively, with respect to a listener.

[4-2] Sound Field Correcting Apparatus

[4-2-1] Configuration of Sound Field Correcting Apparatus

In FIG. 13, a sound field correcting apparatus 20 according to an embodiment of the present invention is illustrated. The sound field correcting apparatus 20 is connected to a signal line between the signal source 11, and the display 12 and the digital amplifier 13. The digital video signal DV output from the signal source 11 is supplied to the display 12 through a delay circuit 21. The delay circuit 21 includes a field memory or the like and provides the video signal DV a delay of a period based on a delay of the digital audio signal DA due to sound field correction, so as to synchronize an image and reproduced sound (i.e., lip-sync).

In addition, in the sound field correcting apparatus 20, the digital audio signal DA is supplied to a decoder 22 and separated into audio signals DC to DRB for the individual channels. The audio signal DC for a center channel is supplied to a correction circuit 23C. This correction circuit 23C includes an equalizer circuit 231 and a switch circuit 232. The audio signal DC from the decoder 22 is supplied to the switch circuit 232 through the equalizer circuit 231.

In this case, the equalizer circuit 231 is constituted by, for example a DSP (Digital Signal Processor) and controls the delay characteristic, frequency characteristic, a phase characteristic, level, etc., of the audio signal DC, so as to perform sound field correction on the signal DC. The switch circuit 232 has such connection depicted in the figure during a normal audio/visual operation. In measurement and analysis operations for sound field correction, the switch circuit 232 has a connection state which is inverted to that depicted in the figure. Thus, in a normal audio/visual operation, the audio signal DC, which has undergone sound field correction, is supplied from the equalizer circuit 231 and then output from the switch circuit 232. The audio signal DC is then fed to an encoder 24.

The remaining audio signals DL to DRB, which has been separated by the decoder 22, are fed to the encoder 24 through correction circuits 23L to 23RB, respectively. Each of the correction circuits 23L to 23RB has the same configuration as the correction circuit 23C. Thus, in a normal audio/visual operation, the audio signals, which have undergone sound field correction, are output from the correction circuits 23L to 23RB, respectively, and then supplied to the encoder 24.

Then, in the encoder 24, the audio signals DC to DRB for the individual channels are converted into a serial signal DS, and this serial signal DS is supplied to the digital amplifier 13. Thus, in a normal audio/visual operation, the audio signal DA output from the signal source 11 undergoes sound field correction through the correction circuits 23C to 23RB and then is supplied to speakers 14C to 14RB. As a result, the audio signal DA is emitted from the speakers 14C to 14RB as reproduction sound which has been corrected so as to be suitable to an environment where the speakers are arranged.

The sound field correcting apparatus 20 also includes a TSP signal forming circuit 31. The TSP signal forming circuit 31 includes a memory to which a TSP signal is written in the form of digital data and a readout circuit for reading the digital data. The TSP signal forming circuit 31 outputs a TSP signal repeatedly for each unit period over the periods T1 to Tk, in accordance with control performed by a controller 35. The TSP signal is supplied to the switch circuits 232 of the correction circuits 23C to 23RB.

In a measurement of a sound field in an acoustic state, a microphone 15 is provided at the listener's position so that TSP sound is picked up. At this time, the microphone 15 is arranged so that its diaphragm is in a horizontal plane so as to be nondirectional. Thus, the microphone 15 has a constant sensitivity regardless of the position and orientation of the speakers.

An output signal SR1 of the microphone 15 is supplied to an analog/digital (A/D) converter 33 through a microphone amplifier 32 and then converted into a digital signal SRi with a sampling frequency of 48 kHz, for example. This digital signal SR1 is supplied to an analysis circuit 34.

The analysis circuit 34 includes a memory 341 and a DSP 342. When the emission of TSP sound is initiated, the DSP 342, using the memory 341, accumulates and averages the output signals SR1 for every unit period TN (for example, 4096-sample period) over the period T1 to T (k+L). Thus, in the end of the period T(k+L) a wrapped signal Sw is provided to the memory 341.

The wrapped signal Sw is analyzed through a scheme described in the foregoing ([1-2]) by the DSP 342, and the result of the analysis is supplied to the controller 35. The controller 35 has a microcomputer so as to perform control of formation of TSP signals in the TSP signal forming circuit 31 and switching of the switch circuits 232. The controller 35 also performs setting of the equalizer circuits 231 of the correction circuit 23C to 23RB in accordance with the analysis result obtained from the analysis circuit 34.

The controller 35 is connected to various operation switches 36 as user interfaces and to a display device such as an LCD panel 37 for displaying an analysis result or the like.

[4-2-2] Operation in Analysis Processing of Sound Field Correcting Apparatus 20

When a setting switch, which is one of the operation switches 36, is operated, the controller 35 inverts the connection of the switch circuits 232 of the correction circuits 23C to 23RB. The controller 35 also controls the TSP signal forming circuit 31, so that a TSP signal is supplied to the switch circuit 232 of the correction circuit 23C. Thus, TSP sound is output over the period T1 to Tk from the speaker 14C. At this time, no sound is output from the speakers of the other channel.

At this time, the TSP sound emitted from the speaker 14C is picked up by the microphone 15. The controller 35 controls the analysis circuit 34 so that analysis processing is initiated. Through this analysis processing, parameters such as the distance between the speaker 14C to the microphone 15 and the frequency characteristic are calculated, and the result is provided to the controller 35. On the basis of the result of the analysis processing, the controller 35 sets the equalizer circuit 231 for sound field correction. Then, the switch circuit 232 are set in the state depicted in the figure, and thus the sound field correction processing for the signal DC for the corresponding channel is terminated. Likewise, setting of sound field correction for the other channels are performed.

Consequently, in a normal audio/visual operation, sound field correction is performed on the audio signals DA output from the signal source 11 by the correction circuits 23C to 23RB. Then, the corrected signals are supplied to the speakers 14C to 14RB, and thus the speakers 14C to 14RB output reproduced sound which has been corrected so as to be suitable to the environment where the speakers are arranged.

[5] Other Implementations

The values used for define the sections A to D (i.e., 0.025, 0.05, and 0.075) and the values used for sectioning the threshold level V_{TH} (i.e., 5%, 20%, and 80%), which are described with reference to FIG. 12, can be other than the those illustrated. In addition, the maximum amplitude values Dx_max may be obtained by squaring an instantaneous value in the detection period Tx or the absolute value of the instantaneous value. Further, although the characteristic in FIG. 12 is indicated by broken lines, a characteristic function indicated by a curve can also be employed. Thus, any characteristic can be employed as long as it serves to determine the threshold level on the basis of data such as a maximum value and average energy in the detection period Tx.

Moreover, to increase accuracy in actual implementation, the threshold level V_{TH} can be configured to be two-phase. For example, a high threshold level V_{THH} is set as a reference threshold level. Then, with the above-described technique, level determination is performed forward along the time axis so that a rising edge is obtained as a dummy rising edge. Subsequently, from the dummy rising edge, level determination is performed backward along the time axis, and a time point where the threshold level is lower than a threshold level T_{HL} (V_{THL}<V_{THH}) is determined to be the actual rising edge. Alternatively, it may also be possible that the level determination is performed backward along the time axis from the dummy rising edge for a predetermined sample value, and a time point that gives the closest value to the dummy rising edge is determined to be the actual rising edge.

Further, it is also possible that the analysis processing is performed on a wrapped signal Sw or an impulse response signal obtained by inversely TSP-transforming the wrapped signal Sw, after is filtered so that the effect of noise and excessive fluctuation of waveform is reduced.

It should be understood by those skilled in the art that various modifications, combinations, sub-combinations and alterations may occur depending on design requirements and other factors insofar as they are within the scope of the appended claims or the equivalents thereof.

1. A method for measuring a frequency characteristic of a system in which the length of an impulse response of the system is greater than a the length N of a time stretched pulse (TSP) signal, the method comprising:
supplying the TSP signal to the system a predetermined number of times;
adding and averaging output signals each having the length N; and
performing circular convolution on a value obtained by the adding and averaging so that the frequency characteristic of the system is obtained.

2. A method for measuring a frequency characteristic of a sound field between a sound source and a receiver, in which
N denotes a length of a TSP signal,
ν denotes a length of an impulse response between the sound source and the receiver,
TN denotes a duration period of the TSP signal, and
at least one period T1 to T (k+L) each composed of the period TN as a unit period (k≧1, L≧0), the method comprising:
setting N so as to satisfy N≦ν;
supplying the TSP signal to the sound source for each unit period TN over at least one period T1 to Tk;
adding and averaging signals output from the receiver during each period of the at lease one period T1 to T (k+L); and
performing circular convolution on a value obtained by the adding and averaging so that the frequency characteristic of the sound field between the sound source and the receiver is obtained.

3. The method of claim 2,
wherein the circular convolution is performed using an FFT or a DFT.

4. The method of claim 3, further comprising:
checking in real time a level of the output signals of the receiver during the periods T (k+1) to T (k+L) among the periods T1 to T (k+L); and
stopping the adding and averaging for each period TN when the output signals of the receiver are at or below a predetermined level with respect to the level of background noise.

5. A method for measuring a rise edge of an impulse response between a sound source and a receiver, in which
N denotes a length of a TSP signal,
ν denotes a length of the impulse response between the sound source and the receiver,
TN denotes a duration period of the TSP signal, and
at least one period T1 to T (k+L) each composed of the period TN as a unit period (k≧1, L≧0), the method comprising the steps of:
setting N so as to satisfy N≦ν
supplying the TSP signal to the sound source continuously for each unit period TN over at least one period T1 to Tk;
adding and averaging signals output from the receiver during each period of the at least one period T1 to T(k+L);
obtaining an impulse response signal between the sound source and the receiver on the basis of a value obtained from the adding and averaging; and
obtaining the rising edge of the impulse response using an amplitude value or an energy value of the impulse response signal, the amplitude value or the energy value to be used being obtained at a time point before the amplitude value or the energy value becomes the maximum value.

6. The method of claim 5,
wherein the obtained rising edge is set as a dummy rising edge, and
wherein an actual rising edge of the impulse response is determined to be at a time point when an amplitude value of the impulse response signal first becomes a predetermined value which is smaller than an amplitude value corresponding to the dummy rising edge, the time point being obtained by tracing retrospectively from the dummy rising edge.

7. A sound field correcting apparatus measuring a frequency characteristic of a sound field between a sound source and a receiver, the sound field correcting apparatus in which
N denotes a length of a TSP signal,
ν denotes a length of an impulse response between the sound source and the receiver,
TN denotes a duration period of the TSP signal, and
at least one period T1 to T (k+L) each composed of the period TN as a unit period (k≧1, L≧0), the sound field correcting apparatus comprising:
a signal forming circuit for generating the TSP signal continuously for each unit period TN over at least one period T1 to Tk, the unit period TN are set so as to satisfy N≦ν;
an output circuit for selecting either an input audio signal or the TSP signal from the signal forming circuit and outputting the selected signal to the sound source;
an analysis circuit for, when TSP sound output from the sound source is picked up by the receiver, analyzing a signal output from the receiver so as to calculate a frequency characteristic of a sound field between the sound source and the receiver; and
a sound field correcting circuit for performing correction of the frequency characteristic on the input audio signal on the basis of the frequency characteristic calculated by the analysis circuit,
wherein
in the analysis of the analysis circuit,
signals output from the receiver during each period of the at least one period T1 to T (k+L) are added and averaged for each unit period TN, and
circular convolution is performed on the added and averaged value so that the frequency characteristic of the sound field between the sound source and the receiver is obtained.
